(19) United States
(12) Patent Application Publication
(10) Pub. No.: US 2013/0064558 A1
(43) Pub. Date: Mar. 14, 2013

(54) IMAGE FORMING DEVICE AND IMAGE FORMING METHOD

(71) Applicant: Yukio Futamata, Shizuoka-ken (JP)

(72) Inventor: Yukio Futamata, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/599,083

(22) Filed: Aug. 30, 2012

Related U.S. Application Data
(60) Provisional application No. 61/532,173, filed on Sep. 8, 2011.

(51) Int. Cl. G03G 15/00

(52) U.S. Cl. 399/15

(57) ABSTRACT

An image forming device includes: a decolorable first developer decolorized by being heated to a certain decolorizing temperature or higher and fixed by being heated to a first fixing temperature lower than the decolorizing temperature; a non-decolorable second developer being fixed at a second fixing temperature higher than the certain decolorizing temperature; a conveying unit to determine a sheet printed by trial printing as a sheet for final printing, the sheet being provided with a first developer image, the conveying unit feeding the sheet for final printing toward a transferring unit to transfer a second developer image on the first developer image on the sheet for final printing; and a controller having a trial printing mode in which the first and second developer images are heated and pressed simultaneously at the second fixing temperature on the sheet for final printing.

### CROSS-REFERENCE TO RELATED APPLICATION

This application is based upon and claims the benefit of priority from: U.S. provisional application 61/532173, filed on Sep. 8, 2011; the entire contents of which are incorporated herein by reference.

### FIELD

Embodiments described herein relate generally to a technique about image formation and decolorization by which an image printed on a sheet with a decolorable color material decolorized by being heated is decolorized and at the same time, an image formed on the sheet with a non-decolorable color material is fixed.

### BACKGROUND

If an image formed on a recording medium such as a sheet is made of a decolorable color material decolorized by being heated to a certain temperature or higher, the recording medium can be reused after the image is decolorized. This contributes to reduction in waste generation and reduction in carbon dioxide. As one of examples of use of such a decolorable color material, the decolorable color material is applied in trial printing performed to check the substance of a document before final printing is performed by an image forming device.

If it is determined as a result of trial printing that the substance of the document is acceptable, final printing is performed by using a non-decolorable color material.

Meanwhile, for reuse of a sheet having been used for trial printing, a dedicated decolorizing device is required to be prepared additionally to perform decolorizing process on a decolorable image in addition to printing of a final document.

Introduction of a decolorizing system requires an image forming device dedicated to a decolorable color material, an image forming device dedicated to a non-decolorable color material, and a decolorizing device dedicated to decolorizing process. Accordingly, introduction of the decolorizing system may increase cost, complicate a task and increase installation space.

Thus, execution of all of trial printing, decolorizing process, and final printing in one device has been desired. Simplification of a task has also been desired.

### DESCRIPTION OF THE DRAWINGS

FIG. 1 is a diagram showing an outline of the structure of an image forming device according to an embodiment;

FIG. 2 is a block diagram of control blocks of the image forming device of FIG. 1 to perform trial printing, decolorizing process, and final printing;

FIG. 3 is a diagram showing an example of an image printed on a sheet by trial printing;

FIG. 4 is a diagram showing an operational unit of the image forming device of FIG. 1 on which a selection screen for trial printing is displayed;

FIG. 5 is a diagram showing the operational unit of the image forming device of FIG. 1 on which a selection screen for the propriety of trial printing is displayed; and

FIG. 6 is a flowchart explaining a flow of control operation by the control blocks of FIG. 2.

### DETAILED DESCRIPTION

An image forming device according to an embodiment is one for forming a developer image on a sheet on the basis of image information.

The image forming device includes: a memory unit to store image information; an electrostatic latent image carrier to hold an electrostatic latent image formed thereon with exposure light on the basis of the image information; a first developing unit to house a decolorable first developer and develop an electrostatic latent image based on image information for trial printing, the first developer being decolorized by being heated to a certain decolorizing temperature or higher and fixed by being heated to a first fixing temperature lower than the decolorizing temperature; a second developing unit to house a non-decolorable second developer and develop an electrostatic latent image based on image information for final printing, the second developer being fixed at a second fixing temperature higher than the certain decolorizing temperature; a transferring unit to transfer a developer image from the electrostatic latent image carrier onto a sheet; a fixing unit to fix the first developer image on a sheet at the first fixing temperature and fix a second developer image on the sheet at the second fixing temperature; a conveying unit to feed the sheet printed by trial printing with the first developer image fixed at the first fixing temperature toward the transferring unit as a sheet for final printing to transfer the second developer image on the first developer image on the sheet for final printing; and a controller having a trial printing mode, the trial printing mode being such that the first and second developer images are heated and pressed simultaneously at the second fixing temperature on the sheet printed by trial printing conveyed from the conveying unit to the fixing unit through the transferring unit, thereby decolorizing the first developer image and fixing the second developer image.

An image forming method of the embodiment forms a developer image on a sheet based on image information.

The image forming method includes: storing image information in a memory unit; forming a first electrostatic latent image on an electrostatic latent image carrier with exposure light defining the image information stored in the memory as image information for trial printing; forming a first developer image by developing the first electrostatic latent image with a decolorable first developer, the first developer being decolorized by being heated to a certain decolorizing temperature or higher and fixed by being heated to a first fixing temperature lower than the decolorizing temperature; after the first developer image is transferred onto a sheet at a transferring unit, fixing the first developer image on the sheet at the first fixing temperature; feeding the sheet printed by trial printing with the fixed first developer image toward the transferring unit as a sheet for final printing; forming a second electrostatic latent image on the electrostatic latent image carrier with exposure light defining the image information stored in the memory as image information for final printing; forming a second developer image by developing the second electrostatic latent image with a non-decolorable second developer, the second developer being fixed at a second fixing temperature higher than the certain decolorizing temperature; transferring the second developer image on the first developer image on the sheet for final printing at the transferring unit; and heating and pressing the first and second developer images simultaneously at the second fixing temperature, thereby decolorizing the first developer image and fixing the second developer image.

The embodiment will be described in detail below by referring to the drawings.

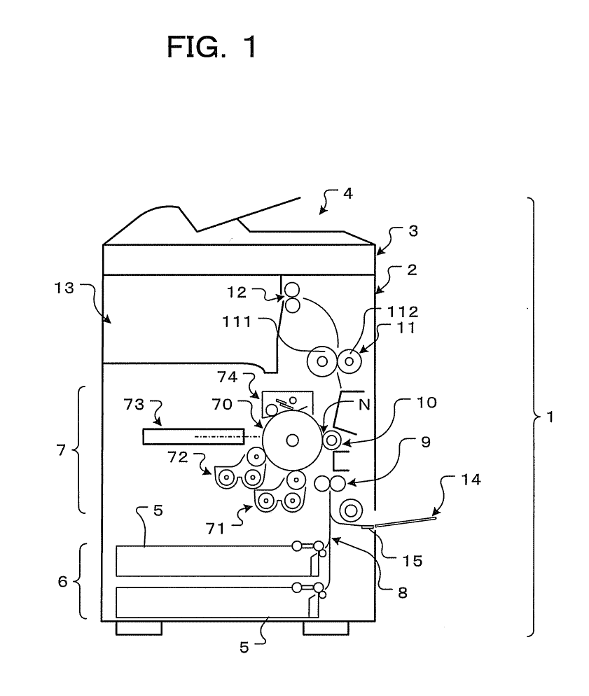

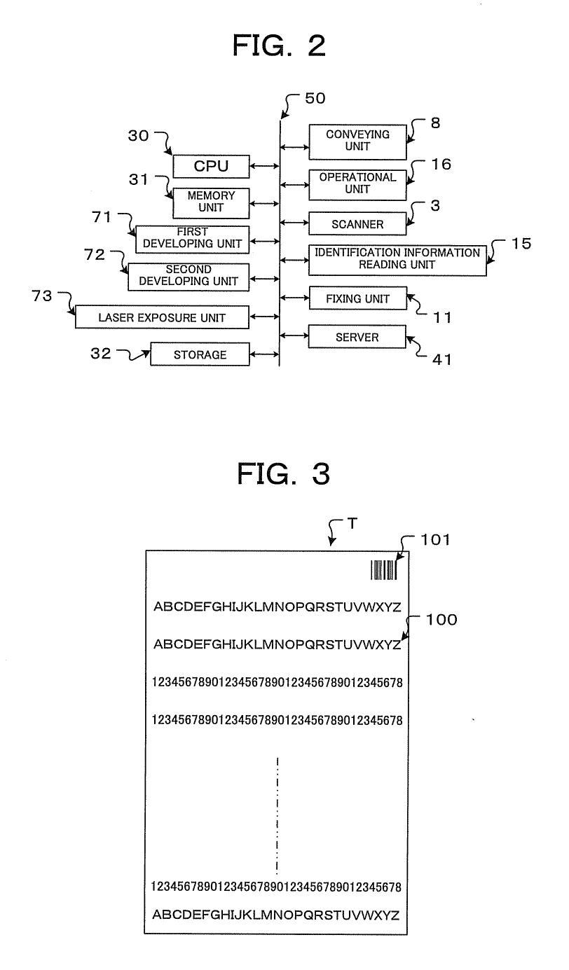

FIG. 1 is a diagram showing an outline of the structure of an image forming device according to the embodiment. FIG. 2 is a block diagram of control blocks of the image forming device of FIG. 1 to perform trial printing, decolorizing process, and final printing. FIG. 3 is a diagram showing an example of a sheet printed by trial printing.

An MFP (multi-function peripheral) having an image forming unit of an electrophotography system is described below as an example of an image forming device 1 of the embodiment.

As shown in FIG. 1, the MFP 1 includes an image reading unit 3 such as a scanner arranged on a device main body 2, and an ADF (automatic document feeder) 4 arranged on the image reading unit 3. The device main body 2 includes a first sheet feeding unit 6 with a plurality of vertically arranged sheet feeding cassettes 5, an image forming unit 7, and a conveying unit 8 to convey a sheet from the first sheet feeding unit to a transfer position N in the image forming unit 7. A sheet having passed through the conveying unit 8 is conveyed by a registration roller pair 9 at given timing toward the transfer position N in the image forming unit 7.

The image forming unit 7 includes a photosensitive drum 70 being an electrostatic latent image carrier, and a first developing unit 71, a second developing unit 72, a laser exposure unit 73, a cleaning device 74 and others arranged to surround the photosensitive drum 70.

The laser exposure unit 73 applies light for image exposure to a surface of the photosensitive drum 70 on the basis of document information read in a memory unit 31 shown in FIG. 2 to form an electrostatic latent image on the surface of the photosensitive drum 70. The electrostatic latent image is developed with a toner of the first or second developing unit 71 or 72. A toner image formed by developing with the toner is transferred at the transfer position N onto a sheet by a transferring roller 10. The sheet having passed through the transfer position N is heated and pressed by a fixing unit 11. The sheet having passed through the fixing unit 11 is discharged by a sheet discharging roller pair 12 onto a sheet discharging unit 13.

For example, the fixing unit 11 includes a heating roller 111, a pressing roller 112 being in contact with the heating roller 111 under pressure, a heat source composed, for example, of a halogen lamp (not shown in the drawings) to heat the heating roller 111, a temperature sensor (not shown in the drawings) to detect the surface temperature of the heating roller 111, and the like. The fixing unit 11 is capable of controlling heating temperature by controlling energization of the halogen lamp.

In the present embodiment, a second sheet feeding unit 14 is further provided that is composed, for example, of a manual sheet feeding tray to feed a sheet to the conveying unit 8. An identification information reading unit 15 is provided to an end portion of sheet feed of the second sheet feeding unit 14. The identification information reading unit 15 reads identification information printed on an end portion (portion in which a document image is not formed) of a sheet in the lowermost position of those placed on the second sheet feeding unit 14. An operational unit 16 with a monitor realizes various operations of the MFP 1.

The first developing unit 71 houses a decolorable toner being a decolorable color material. The second developing unit 72 houses an ordinary toner being a non-decolorable color material. The first and second developing units 71 and 72 apply a predetermined potential difference between a developing roller 711 and the photosensitive drum 70 and between a developing roller 721 and the photosensitive drum 70, respectively, thereby making the photosensitive drum 70 electrostatically support respective toners housed in the first and second developing units 71 and 72.

In the present embodiment, the decolorable toner housed in the first developing unit 71 (hereinafter called a first developer) is composed of a thermoplastic resin as a base material and a color material which is dispersed in the thermoplastic resin and becomes colorless by being heated, for example. The first developer has properties of becoming colorless and transparent by being heated to a decolorizing temperature (T1) of about 120° C. or higher. The first developer is fused by being heated to a first fixing temperature (T2 which is lower than T1) of about 100° C.

The non-decolorable toner housed in the second developing unit 72 (hereinafter called a second developer) is fused by being heated to a second fixing temperature (T3 which is higher than T1) of about 150° C.

Thus, in order to transfer a toner image made of the first developer at the first developing unit 71 on a new sheet or a sheet after being subjected to decolorization and to fix the toner image at the fixing unit 11, the temperature of the fixing unit 11 is set at the first fixing temperature T2. Further, in order to transfer a toner image made of the second developer at the second developing unit 72 on a new sheet or a sheet after being subjected to decolorization and to fix the toner image at the fixing unit 11, the temperature of the fixing unit 11 is set at the second fixing temperature T3.

Further, in order to superimpose a toner image made of the second developer on a sheet on which the first developer is fixed but which has not been subjected to decolorizing process and to fix the toner image made of the second developer, the sheet is heated at the fixing unit 11 heated to the second fixing temperature T3. As a result, a toner image made of the first developer is decolorized and the toner image made of the second developer is fixed to become a permanent image.

To be specific, in the present embodiment, decolorizing process of a fixed toner image being a visible image made of the first developer, and fixing process of an unfixed toner image made of the second developer, can be performed simultaneously.

In the present embodiment, trial printing will be described as an example of such a case where decolorizing process and fixing process of a permanent image are performed simultaneously. For trial printing, a document image is printed on a sheet with the first developer, and the substance of the document is checked. If the substance of the document is acceptable, final printing is performed. For final printing, an original document may be set again on the ADF 4. Meanwhile, a trouble such as missing of a page of the original document may be found during check of the substance of the document. Such a trouble can be avoided if document information having been used for trial printing is used as it is for final printing, so that the substance of the document obtained for trial printing can be reproduced completely in final printing.

Thus, in the present embodiment, identification information is given to document information read in the memory for trial printing. As shown in FIG. 3, identification information 101 in the form of a bar code and the like is formed on a trial printing sheet T separately from document information 100, and is fixed together with the document information 100. If a document targeted for trial printing contains a plurality of pages, the identification information 101 may be printed only on the first page or on all the pages.

In the present embodiment, the trial printing sheet T that also becomes a printing sheet for final printing is set on the second sheet feeding unit 14 for final printing. At this time, the sheet T is set on the second sheet feeding unit 14 such that a printed side points downward to allow the identification information reading unit 15 to read the identification information 101. Based on the identification information 101 thereby read, the identification information reading unit 15 retrieves corresponding document information from the memory unit 31 of FIG. 2. Then, an image made of the second developer is superimposed on a visible image made of the first developer. The image superimposed at this time is an unfixed toner image made of the second developer that is exactly the same as the image made of the first developer. Then, the fixing unit 11 performs heating and pressing processes for final printing. As a result, the fixed image made of the first developer is decolorized and the toner image made of the second developer is fixed as a permanent image.

A flow of control to perform trial printing, decolorizing process and final printing described above will now be described below on the basis of FIG. 2.

As shown in FIG. 2, a processor (CPU) 30 to control the entire MFP 1, the memory unit 31 to store printing data and the like, a storage 32, the first and second developing units 71 and 72, the exposure unit 73, the conveying unit 8, the operational unit 16, the image reading unit (scanner) 3, the fixing unit 11, and the identification information reading unit 15 are connected to each other through a bus line 50. Further, a personal computer and a server 41 are connected through interfaces to the bus line 50 in the MFP 1.

Document information read by the image reading unit 3 or document information transmitted from the personal computer is read into the memory unit 31.

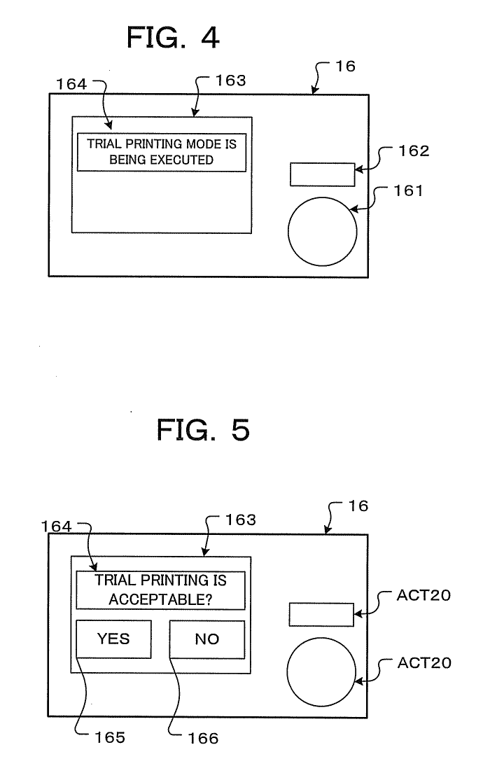

As shown FIGS. 4 and 5, the operational unit 16 has a start switch 161, a trial printing mode selection switch 162, and a monitor 163. During execution of a trial printing mode, a message inquiring about the propriety of trial printing is displayed, for example, in a message region 164 of the monitor 163 on the operational unit 16 as shown in FIG. 5. The operation unit 16 can display a first switch section 165 and a second switch section 166. If trial printing is acceptable, an operator presses the first switch section 165 to execute final printing. If trial printing includes some problems, the operator presses the second switch section 166 not to execute final printing.

The processor 30 executes predetermined process on the basis of a program stored in the memory unit 31 or the storage 32 to control operation of image formation. A RAM (random access memory), a ROM (read-only memory), a DRAM, an SRAM (static random access memory), a VRAM (video RAN), or a flash memory can be used as the memory unit 31, for example. The memory unit 31 functions to store various types of information and various programs used in the MFP 1.

The CPU 30 executes the trial printing mode if an operator selects the trial printing mode by pressing the trial printing mode selection switch 162 on the operational unit 16. When the trial printing mode is started, the CPU 30 controls the laser exposure unit 73 on the basis of document image information read in the memory unit 31 to form an electrostatic latent image of the document image information and an electrostatic latent image of identification information on the photosensitive drum 70. These electrostatic latent images are developed with the first developer in the first developing unit 71 to form decolorable toner images. Then, the transferring roller 10 forms the decolorable toner images made of the first developer on a sheet T. Further, the fixing unit 11 fixes the toner images made of the first developer. The sheet discharging roller pair 12 discharges the trial printing sheet T after being subjected to fixation onto the sheet discharging unit 13. The document information 100 and the identification information 101 are printed on a first side of the trial printing sheet T after being subjected to fixation as shown in FIG. 3.

In the trial printing mode, the CPU 30 sets the fixing temperature of the fixing unit 11 to fix the toner images made of the first developer on the trial printing sheet T at the first fixing temperature T2.

The operator checks the substance of the print on the trial printing sheet T, and performs final printing on the first side of the trial printing sheet T if the substance is acceptable. FIG. 5 shows an operational screen on which the propriety of trial printing is selected. If trial printing is acceptable, the first switch section 165 is pressed. If the substance of trial printing involves correction and the like and the trial printing mode is to be finished once, the second switch section 166 is pressed. If the trial printing mode is finished for correction, for example, the document image information and its identification information are deleted together from the memory unit 31, so that they will not be read by mistake.

In the present embodiment, if the substance of trial printing is acceptable, the trial printing sheet T after being checked is placed on the tray of the second sheet feeding unit 14 in order to perform the final printing. At this time, the trial printing sheet T is placed on the tray such that the first side thereof points downward to allow the identification information reading unit 15 to read the identification information 101.

The identification information reading unit 15 retrieves document information stored in the memory unit 31. At this time, identification information may be retrieved together for printing, or may not be retrieved so that it will not be printed. If identification information is to be printed together with the document information during final printing, only the identification information may be printed, or information such as a source and a destination of distribution and date and time of printing may be added.

For final printing, the second developing unit 72 is selected, and a toner image made of the second developer is transferred onto the first side of the trial printing sheet T before being subjected to decolorizing process. Then, the fixing unit 11 performs fixing at the second fixing temperature T3. The second fixing temperature T3 is higher than the decolorizing temperature T1 of the first developer. Accordingly, the toner image made of the second developer is fixed and the toner image made of the first developer is decolorized simultaneously.

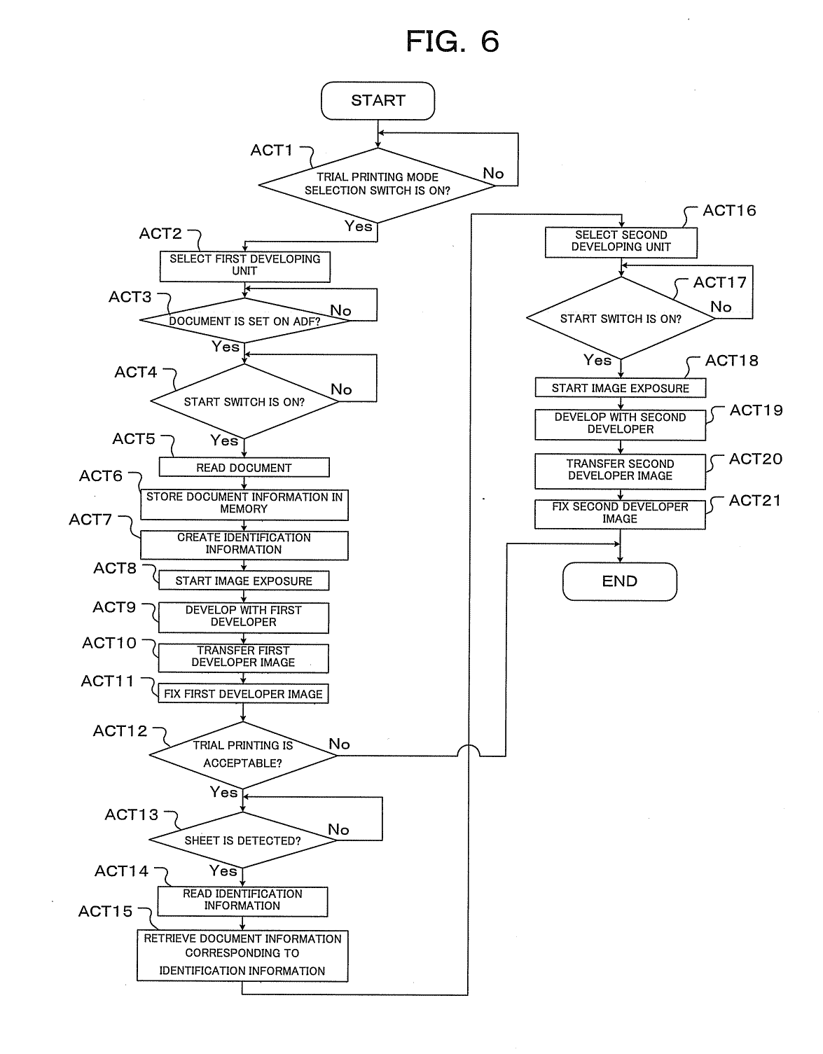

A flow of printing process in the aforementioned trial printing mode will now be described below on the basis of the flowchart of FIG. 6. In the trial printing mode described as an example below, document information for trial printing is one read by the image reading unit 3 from a document set on the ADF 4.

In ACT 1, it is expected that the trial printing mode selection switch 162 on the operational unit 16 will be made ON. If the trial printing mode selection switch 162 is made ON, the process flow proceeds to ACT 2.

In ACT 2, development by the first developing unit 71 is selected. Then, the process flow proceeds to ACT 3.

In ACT 3, it is determined if a document is set on the ADF 4. This determination is made on the basis of the presence or absence of a document determined by a sheet detecting sensor of the ADF 4. If a document is set on the ADF 4, the process flow proceeds to ACT 4. It is expected in ACT 4 that the start switch 161 on the operational unit 16 will be made ON. If the start switch 161 is made ON, the process flow proceeds to ACT 5.

In ACT 5, the ADF 4 is started to start reading of the document by the image reading unit 3. In ACT 6, document information read is stored in the memory unit 31. Then, the process flow proceeds to ACT 7.

In ACT 7, identification information is created, and the identification information thereby created is added to the document information stored in the memory unit 31. Then, the process flow proceeds to ACT 8.

In ACT 8, image exposure for the identification information and the document information is started to form electrostatic latent images on the photosensitive drum 70. Then, the process flow proceeds to ACT 9. The identification information may be given only on the first page or on all pages.

In ACT 9, development is performed by using the first developer in the first developing unit 71 to form first developer images. In ACT 10, the first developer images are transferred onto a sheet. Then, the process flow proceeds to ACT 11.

In ACT 11, the fixing unit 11 set at the first fixing temperature T2 fixes the first developer images to perform trial printing. Since the decolorizing temperature T1 of the first developer used for trial printing is higher than the first fixing temperature T2 thereof, the first developer images can be fixed without being decolorized. Then, the trial printing sheet T is discharged onto the sheet discharging unit 13, and the process flow proceeds to ACT 12.

In ACT 12, indication inquiring about the propriety of trial printing is displayed in the message region 164 of the monitor 163 as shown in FIG. 5 to wait for the press of the first or second switch section 165 or 166 by an operator.

The operator checks the substance of the print on the trial printing sheet T. If the substance of trial printing is acceptable, the operator presses the first switch section 165. If the substance of trial printing includes some problems, the operator presses the second switch section 166. If the first switch section 165 is pressed for final printing, the process flow proceeds to ACT 13. If the second switch section 166 is pressed, the trial printing mode is finished.

In ACT 13, it is expected that the sheet will be placed on the second sheet feeding unit 14 for final printing. If a sheet detecting sensor of the second sheet feeding unit 14 detects the trial printing sheet T, the process flow proceeds to ACT 14. For final printing, the trial printing sheet T after being checked for final printing is placed on the second sheet feeding unit 14 such that a first side thereof on which the images not having been decolorized points downward as shown in FIG. 1.

In ACT 14, the identification information reading unit 15 reads the identification information on the trial printing sheet T. Then, document information corresponding to the identification information is retrieved (ACT 15), the second developing unit 72 is selected in ACT 16, and the process flow proceeds to ACT 17.

In ACT 17, it is expected that the start switch 161 will be made ON for final printing. If the start switch 161 is made ON, image exposure is started on the basis of the document information determined to be acceptable as a result of trial printing (ACT 18), and an electrostatic latent image formed on the photosensitive drum 70 is developed with the second developer to form a second developer image (ACT 19). Then, the process flow proceeds to ACT 20.

In ACT 20, the conveying unit 8 conveys the trial printing sheet T with the fixed first developer images not having been decolorized placed on the second sheet feeding unit 14 toward the transfer position N. The second developer image is transferred onto the first side of the trial printing sheet T at the transfer position N, and the process flow proceeds to ACT 21.

In ACT 21, the fixing unit 11 set at the second fixing temperature T3 heats and presses the first developer images not having been decolorized and the second developer image superimposed on the first developer images simultaneously. Since the heating temperature applied at this time is the second fixing temperature T3 (about 150° C.) higher than the decolorizing temperature T1 (about 100° C.), the first developer images are decolorized and the second developer image is fixed simultaneously. Then, the aforementioned trial printing mode is finished.

While printing of a document on the ADF 4 is described as an example of the embodiment, document information from the personal computer may be printed in the trial printing mode. In this case, image information from the personal computer is stored in the memory unit 31 in ACT 3. If the start switch 161 is made ON in ACT 4, the process flow proceeds to ACT 7 to create identification information, and then processes in ACT 8 and in following ACTs are performed.

As described above, the first developer images made unnecessary as a result of trial printing are decolorized and the second developer image is fixed simultaneously in final printing. This contributes to power saving and eliminates the need to prepare a decolorizing device additionally. Further, operation dedicated to decolorizing process becomes unnecessary.

If a need for correction and the like is required as a result of check of trial printing, the trial printing sheet T determined to be unnecessary cannot be used for final printing, so that it is not placed on the second sheet feeding unit 14. Then, this trial printing sheet T is stored in the sheet feeding cassette 5 of the first sheet feeding unit 6, and can be used for ordinary printing using the second developing unit 72, for example. In this case, decolorization and fixing of a second developer image can be performed simultaneously. For storage of the unnecessary trial printing sheet T in the sheet feeding cassette 5, the trial printing sheet T may be placed on the sheet feeding cassette 5 manually by pulling the sheet feeding cassette 5 out toward the front side of the device main body 2. Or alternatively, a plurality of trial printing sheets T may be supplied automatically from the ADF 4 to the sheet feeding cassette 5 through a sheet feed conveying path provided between the ADF 4 and the sheet feeding cassette 5, for example.

While the second developing unit 72 is described as being for a single color, it may be formed as a developing unit for a plurality of colors. In this case, an endlessly rotating transferring belt can serve as an electrostatic latent image carrier, and the first developing unit 71 and the second developing unit 72 for a plurality of colors can be arranged on the transferring belt.

The embodiment can be implemented in various different forms without departing from the spirit or main characteristics of the embodiment. Thus, the embodiment described herein is in all respects merely illustrative, and is not restrictive. The scope of the embodiment is as stated in the claims and is never restricted by the body of the specification. Further, all modifications, various changes, alternatives, and reformations that come within the meaning and range of equivalency of the claims are intended to be encompassed herein.

What is claimed is:

1. An image forming device that forms a developer image on a sheet on the basis of image information, the image forming device comprising:
a memory unit configured to store image information;
an electrostatic latent image carrier configured to hold an electrostatic latent image formed thereon with exposure light on the basis of the image information;
a first developing unit configured to house a decolorable first developer and develop an electrostatic latent image based on image information for trial printing, the first developer being decolorized by being heated to a certain decolorizing temperature or higher and fixed by being heated to a first fixing temperature lower than the decolorizing temperature;
a second developing unit configured to house a non-decolorable second developer and develop an electrostatic latent image based on image information for final printing, the second developer being fixed at a second fixing temperature higher than the certain decolorizing temperature;
a transferring unit configured to transfer a developer image from the electrostatic latent image carrier onto a sheet;
a fixing unit configured to fix a first developer image on a sheet at the first fixing temperature and fix a second developer image on the sheet at the second fixing temperature;
a conveying unit configured to feed the sheet printed by trial printing with the first developer image fixed at the first fixing temperature toward the transferring unit as a sheet for final printing to transfer the second developer image on the first developer image on the sheet for final printing; and
a controller having a trial printing mode, the trial printing mode being such that the first and second developer images are heated and pressed simultaneously at the second fixing temperature on the sheet printed by trial printing conveyed from the conveying unit to the fixing unit through the transferring unit, thereby decolorizing the first developer image and fixing the second developer image.

2. The image forming device according to claim 1, further comprising an identification information creating unit configured to create identification information to be added to the image information stored in the memory unit and form the identification information on the sheet printed by trial printing.

3. The image forming device according to claim 2, further comprising
an identification information reading unit configured to read the identification information formed on the sheet printed by trial printing, and
an image information retrieving unit configured to retrieve the image information given the identification information read by the identification information reading unit from the memory unit and utilize the retrieved image information as the image information for final printing.

4. The image forming device according to claim 1, wherein the image information for trial printing and the image information for final printing are the same image information.

5. The image forming device according to claim 1, comprising a sheet feeding unit configured to hold the sheet with the fixed first developer image to transfer the second developer image on the sheet.

6. An image forming method that forms a developer image on a sheet on the basis of image information, the method comprising:
storing image information in a memory unit;
forming a first electrostatic latent image on an electrostatic latent image carrier with exposure light defining the image information stored in the memory unit as image information for trial printing;
forming a first developer image by developing the first electrostatic latent image with a decolorable first developer, the first developer being decolorized by being heated to a certain decolorizing temperature or higher and fixed by being heated to a first fixing temperature lower than the decolorizing temperature;
after the first developer image is transferred onto a sheet at a transferring unit, fixing the first developer image on the sheet at the first fixing temperature;
feeding the sheet printed by trial printing with the fixed first developer image toward the transferring unit as a sheet for final printing;
forming a second electrostatic latent image on the electrostatic latent image carrier with exposure light defining the image information stored in the memory unit as image information for final printing;
forming a second developer image by developing the second electrostatic latent image with a non-decolorable second developer, the second developer being fixed at a second fixing temperature higher than the certain decolorizing temperature;
transferring the second developer image on the first developer image on the sheet for final printing at the transferring unit; and
heating and pressing the first and second developer images simultaneously at the second fixing temperature, thereby decolorizing the first developer image and fixing the second developer image.

7. The image forming method according to claim 6, further comprising: giving identification information to the image information for trial printing; forming the identification information on the sheet printed by trial printing; causing an identification information reading unit to read the identification information formed on the sheet printed by trial printing; and retrieving the image information given the read identification information from the memory unit to utilize the retrieved image information as the image information for final printing.

8. The image forming method according to claim 6, wherein the image information for trial printing and the image information for final printing are the same image information.
